(19) United States
(12) Patent Application Publication
(10) Pub. No.: US 2006/0089863 A1
(43) Pub. Date: Apr. 27, 2006

(54) Service management for multi-compartment vehicles

(76) Inventors: Marc Belleau, Charlesbourg (CA); Richard Schupbach, St-Nicolas (CA)

Correspondence Address: Schwegman, Lundberg,;Woessner & Kluth, P.A., P.O. Box 2938, Minneapolis, MN, 55402, US

(21) Appl. No.: 11/227,447

(22) Filed: Sep. 15, 2005

(30) Foreign Application Priority Data
Sep. 15, 2004 (CA) 2,480,544

(51) Int. Cl. G01C 21/34

(52) U.S. Cl. 705/6

(57) ABSTRACT

A process and method for optimizing the placement of at least one depot stop within a predetermined delivery route. The invention provides an evaluation of each compartment in a multi-compartment vehicle in order to determine the optimal placement of depots along the route. This optimization is performed both for deliveries and pick-ups along the route, which results in a reduction of costly returns to the depot in the middle of the route.

### FIELD OF THE INVENTION

The present invention relates for service management for multi-compartment vehicles.

### BACKGROUND OF THE INVENTION

Fleet management systems allow the generation and optimization of routes used by vehicles to better serve customers, reduce operating costs, and improve asset utilization. Each route has a sequence of stops where a service has to be done, for example a pick-up or a delivery. Existing systems, however, are not adapted to manage services within multi-compartment vehicles. The management of such vehicle must respect rules and constraints typical to this kind of fleet, among others product incompatibility, volume available in the compartment, etc. Moreover, existing systems will sometimes generate invalid routes that should have been rejected in the first place.

### SUMMARY OF THE INVENTION

The current invention aims at answering the need for service management within multi-compartment vehicles. This invention can become part of existing processes in fleet management systems to management services to be executed using multi-compartment vehicles. It can also be used to report any capacity problem within a predefined stop sequence and allow the insertion of a depot when necessary.

In accordance with one aspect of the invention, there is provided a system for optimizing the placement of at least one depot stop within a predetermined delivery route, said delivery route including deliveries, pick-ups or a combination thereof of at least two different services, for a multi-compartment vehicle, each compartment being associated with at least one service and being characterized by weight, volume and capacity and by incompatible services, said system comprising:
means for assigning starting quantities to each compartment;
means for evaluating said compartments in order to determine an optimal placement of said at least one depot stop, said means being adapted to:
   create a transaction for each service at each stop;
   scan each transaction to determine whether it is a delivery or a pick-up;
   in the case of a delivery, for each compartment, determine if the service is incompatible, if there is underflow or overflow of the compartment and if the delivery can be split and reduce the quantity of the service in the respective compartment by using starting quantity if necessary;
   in the case of a pick-up, for each compartment, determine if the service is incompatible, if there is overflow of the compartment and if the pick-up can be split, and updating the quantity of the compartment if the pick-up can be inserted into the compartment; and
   repeating the steps until all services including previous stop services have been treated at said stop and moving to the next stop, where if said means determine an overflow condition, or an underflow condition, a depot stop is inserted into said route.

In accordance with another aspect of the invention, there is provided a computer implemented method for optimizing the placement of at least one depot stop within a predetermined delivery route, said delivery route including deliveries, pick-ups or a combination thereof of at least two different services, for a multi-compartment vehicle, each compartment being associated with at least one service and being characterized by weight, volume and capacity and by incompatible services, said method comprising the steps of:
assigning starting quantities to each compartment;
calculating an optimized placement for a depot virtual position for said vehicle based on services required by said customers and capacity of said compartments in order to avoid unnecessary stops at depots, said step of calculating including the sub-steps of:
   creating a transaction for each service at each stop;
   scanning each transaction to determine whether it is a delivery or a pick-up;
   if it is a delivery, for each compartment, determining if the service is incompatible, if there is underflow or overflow of the compartment and if the delivery can be split, and then reducing the quantity of the service in the respective compartment by using starting quantity if necessary;
   if it is a pick-up, for each compartment, determining if the service is incompatible, if there is overflow of the compartment and if the pick-up can be split, and updating the quantity of the compartment if the pick-up can be inserted into the compartment; and
   repeating the above steps until all services including previous stop services have been treated at said stop and moving to the next stop;
   inserting a depot stop in said route when an overflow condition or an underflow condition has been determined.

### BRIEF DESCRIPTION OF THE DRAWINGS

The present invention will be better understood by reading a description of a preferred embodiment thereof, made in reference to the following drawings, in which:

FIG. 1 is a schematic representation of a multi-compartment vehicle;

FIG. 2 is a block diagram illustrating how each compartment of a vehicle is associated with one or more services;

FIGS. 3.1, 3.2, 3.3, 3.4 and 3.5 illustrate the result of the optimization of the route according to a preferred embodiment of the invention;

FIG. 4 is a similar representation as of FIG. 3, where a depot is inserted at the beginning of the route;

FIG. 5 is a flowchart of the overflow determination; and

FIG. 6 is a flowchart of the optimization module, entitled “Is Compartment Overflow”.

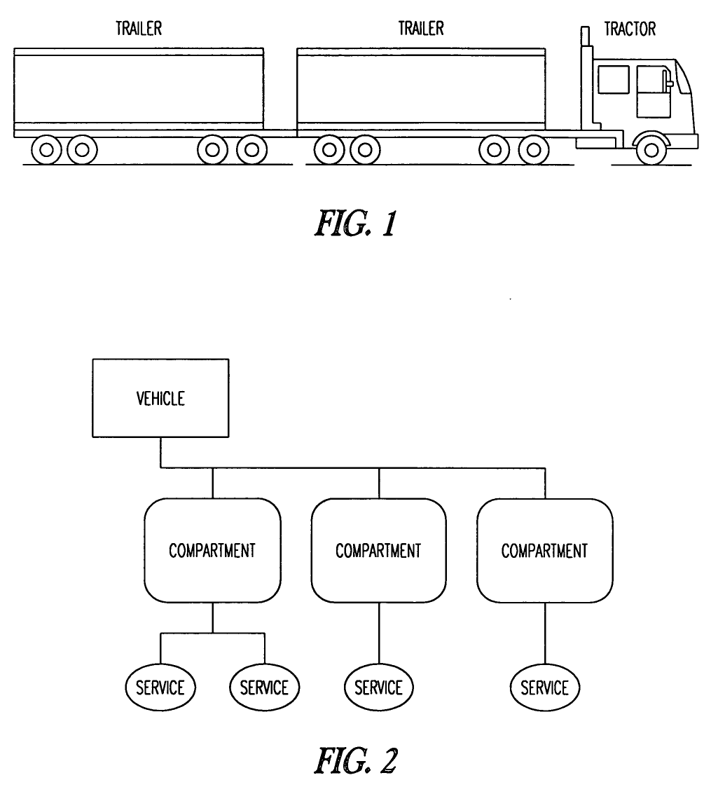

### DESCRIPTION OF A PREFERRED EMBODIMENT OF THE INVENTION

The following description is based on a multi-compartment vehicle used for pick-up and delivery of products. It is important to note that the invention is not limited to this context; other vehicle types and services can also be used. It should also be noted that the present invention can be used as a module for pre-existing route algorithms, and that the present invention presupposes that an existing route has already been established. The purpose of the present invention is to optimize the placement of a depot stop within a predetermined route, as will appear hereinafter.

In some industries, multiple products can be delivered to a single customer, and it is possible that those products cannot be contained in the same compartment. To avoid serving all the customers of a particular product first and then customers of a second product, compartmentalized vehicles are used to allow multiple products to be present in a vehicle at the same time. It is therefore possible to serve several customers with completely different products with only one vehicle. A good example would be a fuel truck: divided in multiple compartments, it allows the delivery of different types of fuel without mixing the products. It is important to manage pick-ups and deliveries of a multi-compartment vehicle to reach an optimal solution. This is done by managing services by compartment in accordance with the present invention.

The process within the invention also implies the management of compartmentalized quantities. A vehicle can carry several products (services) within the same space, it is however possible that this space is divided in compartments to avoid contacts and space loss in the vehicle. For example, regular unleaded gasoline, diesel and supreme unleaded gasoline can be contained in the same vehicle without being in contact with one another, as long as the vehicle has compartments adapted to contain such products. In this case, each product is contained in a specific compartment and its quantity is limited by the total capacity of the compartment, not the vehicle's total capacity.

Depending on the type of service the vehicle executes, the quantity, weight and volume occupied by a product once inserted in a vehicle can be calculated. These three types of information are usually considered when evaluating compartments.

With this data, it is possible to manage the vehicle's capacities and determine efficiently at what point in the route the vehicle has reached its full capacity and needs to return to the depot to be filled.

In the fuel vehicle example, the compartments might already contain products at the beginning of the stops sequence, filled the day before. Starting quantities need to be dealt with to ensure the maximization of the capacity.

In this same example, unleaded gasoline and diesel cannot be mixed. If the unleaded gasoline compartment became empty, it could be used for diesel, on the condition that the compartment would have to be cleaned up first. This is the service incompatibility concept that will be described later.

Vehicle Definition

To define compartments for a vehicle, entities are assigned to this vehicle, which will then be interpreted as parts of the vehicle. A vehicle is made of
a tractor: the front of the truck where the driver sits
a trailer: pulled by the tractor, usually contains the good

Several trailers can be hooked together to form a vehicle to transport many different products. For a fuel truck, the compartments are part of a single trailer.

Each trailer can have its own set of characteristics, among others its height, width, capacity, and the weight and services it can carry. These attributes are used when managing the products to be inserted. To do so, the following values can be considered:
Maximum volume defined in cubic feet, or cubic meters;
Maximum weight defined in pounds or kilograms;
Maximum capacity defined in gallons or liters;
Services that can be performed by the trailer.

A compartment can contain several different types of services, at the same time or one after the other. In this last example, it's called service incompatibility. Each service can determine its maximum quantity independently from the vehicle's, as well as its starting quantity. At the beginning of the day, products can be present in compartments, which we call starting quantities.

A vehicle can be described, in a nutshell, as a set of compartments to which specific services are associated.

Data Definition

When placing an order, the customer needs to specify if it's a request for a delivery or a pick-up, and the quantities of each product ordered.

Products or services placed in the vehicle have their own characteristics that will help the system determine the best compartment in which to insert them. Each service can have the following characteristic:
Weight;
Volume;
Capacity;
Services with which it can't be mixed.

The service incompatibility, also called restriction, is set on two services or more, meaning that if the first service is already present in the vehicle, the second cannot be inserted. Some services will allow the insertion of an incompatible service once the first one has been dropped at the depot and no quantity remains in the vehicle. Other services will not allow an incompatible service to be placed in the vehicle for the rest of the route.

Overflow Evaluation

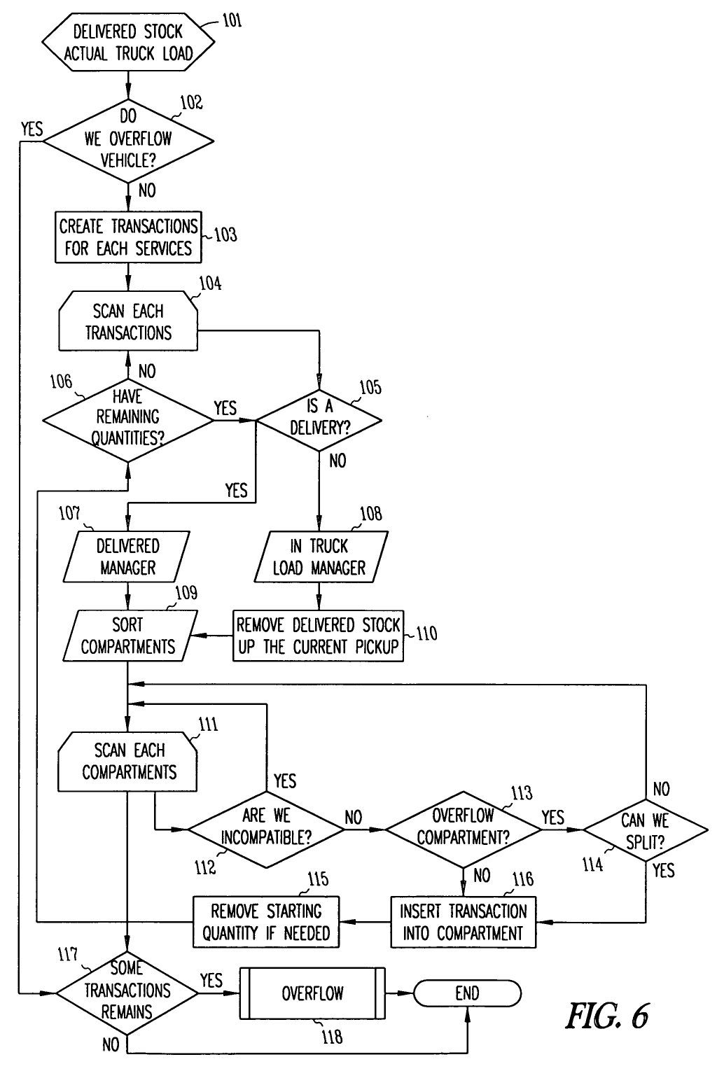

When referring to FIG. 5, each vehicle has a schedule which contains several stops where services will be performed. Each service will either be a pick-up or a delivery, as illustrated by block 6 and 7. Products to be delivered will be placed in one of the vehicle's compartments at the depot and be dropped at the customer's site, and pick-up orders will be placed in the vehicle's compartment at the client's and be delivered at one of the depots. Weight, volume, capacity, and product type will be analyzed to decide where a product should be placed in the vehicle to maximize its insertion and reduce expensive returns to the depot.

To determine when the vehicle reaches its maximum capacity, a virtual position system is used. This system is filled with products associated to future orders (pick-up or delivery), as illustrated by block 4 of FIG. 5. This system will give the maximal position when the vehicle has reached a capacity, as illustrated by block 9. It will also provide the number of potential orders for this sequence.

Once the maximal position is obtained, the stops quantities can be moved chronologically until this position is reached, where a depot will be inserted. Pick-up orders can be added, and potential deliveries reduced. At this phase, the starting quantities must be considered, which can have an impact on the available space in the vehicle and on the deliveries until the next depot.

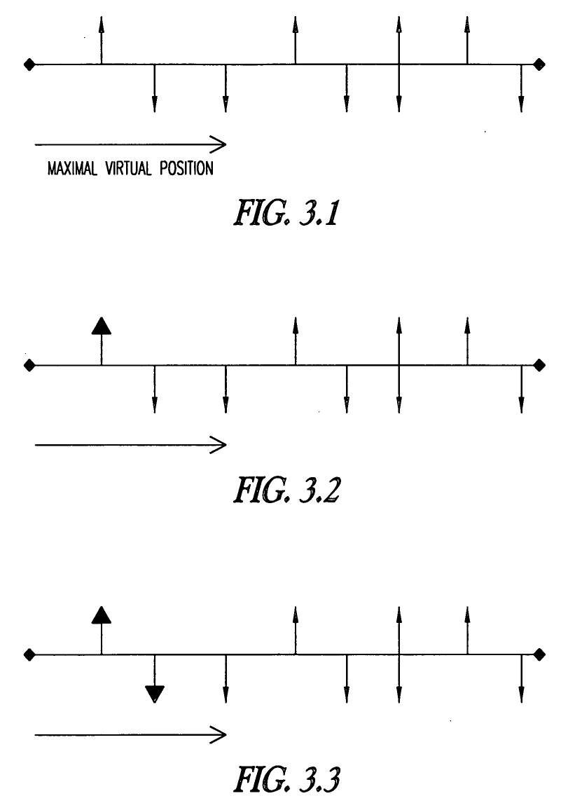

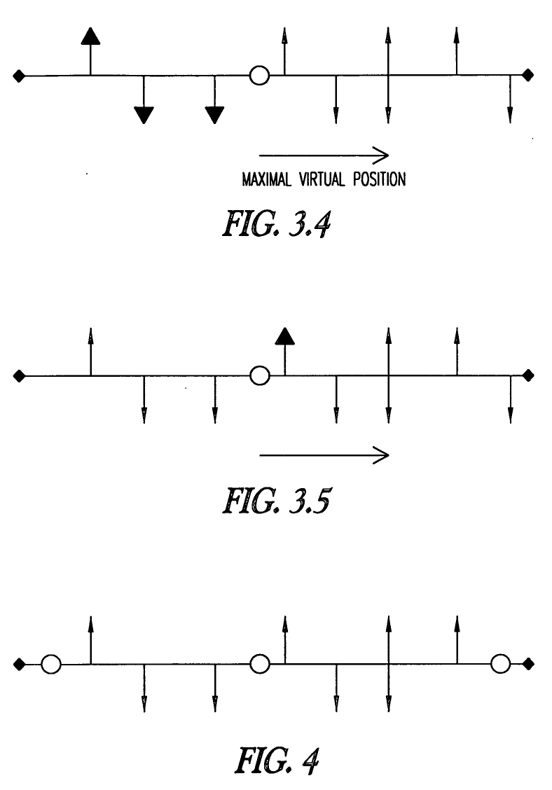

In FIG. 3, the virtual stops sequence is represented by a horizontal arrow. It symbolizes the evolution in time for each service evaluated. Arrows going up represent pick-ups, arrows going down represent deliveries. The bigger arrows stand for pick-ups and deliveries considered during the process, and circles represent return to a depot. A maximum virtual position, shown in FIG. 3.1 will help illustrate the invention.

The first pick-up is performed without problems at FIG. 3.2.

The first delivery is executed without problems at FIG. 3.3.

The second delivery was planned and can be done (FIG. 3.4). The maximal virtual position reached, a depot must be inserted to continue with the remaining stops.

The same process is repeated for the first pick-up after the depot.

The start location can affect the next return to the depot if it is considered as a depot, as illustrated in block 3 of FIG. 5. A vehicle starting its route can already be full of deliveries before the first stop, or it can be empty and will need to back to the nearest depot.

One of the main elements of the process is the evaluation of the compartments, i.e. the way the services will be placed in the vehicle to maximize the space. This function is called “Is Overflowing Compartment” and is executed for each service inserted in the vehicle. It will assess the possibility of inserting the stops services and if those services are compatible with the ones already placed in the vehicle.

More specifically, this process starts at block 101, and a determination as to whether the vehicle overflows is done. Then, at block 103, a transaction is created for each service. The transactions are scanned 104 and a determination as to whether the transaction is a delivery 106

If the transaction is a delivery, the delivery manager is invoked 107, and then the compartments are sorted 109. For each compartment, the optimization module is then applied. Indeed, for each compartment, a determination is made as to whether the service is compatible 112, there is overflow 113 and whether the delivery can be split. If any of these criteria fail, then the process moves to the next compartment until all compartments have been sorted.

If the transaction is a pick-up, the in-load truck manager is invoked 108, and then the delivered stock is removed up the current pick-up 110. Then, the optimization module referred to above is then applied.

The end of the route can have an impact on the last return to the depot, meaning that the products picked-up after the last depot needs to be dropped before the end of the route, as illustrated by block 10 of FIG. 5.

Incompatibility between products can be reset by a return to the depot. If a product is already present in a compartment and another product can only be inserted in that same compartment, there's a service incompatibility. The second product will be inserted only if it is specified that the restriction between the two services can be reset when the first product is completely dropped and a return to the depot allowed the compartment to be cleaned up. If this is the case, the second product will be inserted only after the return to the depot following the first product's delivery.

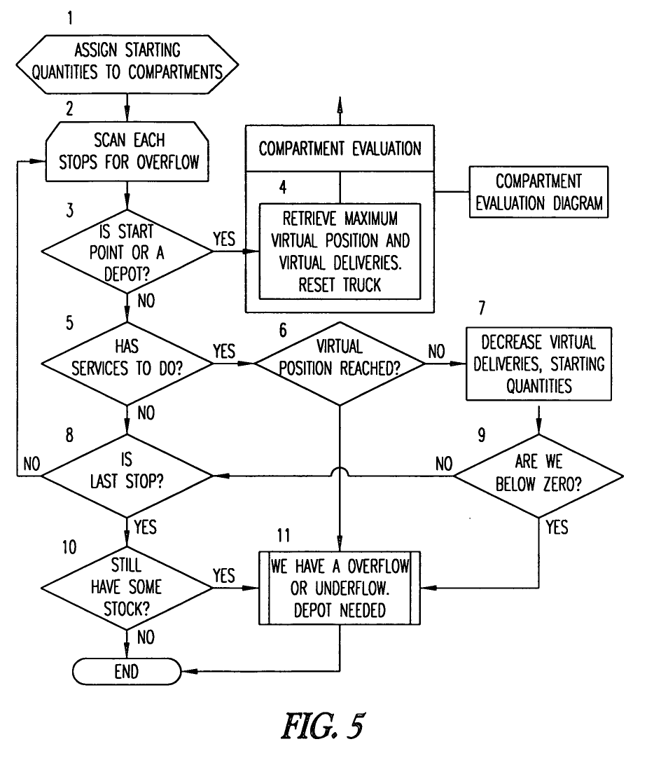

In FIG. 4, a depot is inserted at the beginning of the route to allow deliveries until the next depot is reached, and the depot at the end of the route is inserted to drop the remaining product from the pick-ups done since the last depot.

Compartments

The service distribution between the different compartments is done in two phases. First, the services are converted into transactions that are ordered by time and quantity. Second, the compartments are ordered by their available space and service restrictions. Once these two phases completed, the system will try to insert these transactions into the different compartments.

Transactions

The scheduling of the transactions is done first to allow the prioritization of the services among them, thus reserving space for the products in the vehicle.

The deliveries must be considered first to ensure there's enough space in the vehicle, pick-ups will take the remaining space. As a second step, the deliveries with bigger quantities are scheduled first because they are harder to insert in the vehicle, then a sequential number is assigned to each, representing their position in the route. The pick-ups will be scheduled after the deliveries in a sequential order.

Consequently, if an important quantity of apples needs to be placed for a future delivery, it will be evaluated first because it is more limited due to its quantity. However, a small pick-up of pineapples will be placed later in the vehicle, for example after the position of the apples is fixed, which must be inserted at the last depot.

Compartments

The compartment's scheduling will be executed for each transaction evaluation to make sure to use compartments that are more likely to cause problems due to their physical limitation (remaining space in the vehicle), the number services the vehicles can perform and the defined order stated in the data model.

A compartment with little remaining space will be less interesting for the system to place products into it. The same goes for a compartment that can perform several different services. If a compartment can only perform one service, it will be easier to place the product in that compartment and keep the other compartments that can do multiple services used for these other products.

Space used by products in the vehicle can come from three sources: starting quantities, pick-ups already done, deliveries to be made. The available space is simply calculated by subtracting from the service's maximum quantity the used space.

A compartment won't be considered when evaluating a transaction if this compartment already contains an incompatible service (from another delivery, pick-up or starting quantity) to the transaction's service.

If many compartments are similar, they will be evaluated in the order they were created, allowing the user to specify the order of insertion.

Compartment Evaluation

When referring to FIG. 6, different information must be provided for the evaluation, for example the delivered stock, the actual truck load, as well as the services that would be inserted, as illustrated in block 101. Each historical information must specify where and what quantity is placed in each compartment.

With these first two pieces of information, the system knows what is already in the vehicle when evaluating the transactions, and what has been in the vehicle to make sure no product incompatibility occurs.

Evaluation of each transaction is then performed to determine in which compartment the transactions can be placed, as illustrated by block 104. If the transaction is a pick-up, an evaluation has to be made to make sure enough space remains in the compartment to place that service. This will be assessed by checking the actual truck load since the last return to a depot, as illustrated by bloc 108, and remove the deliveries done since that depot, as illustrated by block 110. If the transaction is a delivery, it is evaluated with the previous deliveries (see block 107).

As mentioned previously, once the compartments are ordered, as described earlier, the system can validate if the transaction is incompatible or exceeds the capacity of the first compartment, the second compartment, and so on, as illustrated by block 109, 111, 112, and 113. If none of the compartments can accept the service, the service is then in error, it is possible to identify the problem or simply reject the service, depending on the chosen algorithm.

It is possible that a transaction cannot completely be placed in a single compartment, in which case a second compartment can be used, as illustrated by block 114 and 116. This transaction would be divided, one part placed in a compartment and the remaining quantity of the transaction assigned to a second compartment, as illustrated by block 105. If it is not possible to assign the remaining quantity of the transaction, there's a problem with that service, and therefore with this client. It is possible to reject this customer from the route, or warn that there is a capacity problem.

The quantity used for a delivery can come from the starting quantity already in the vehicle, as illustrated by block 115 of FIG. 6. The maximum quantity is deduced from this starting quantity, and if more is needed, it will come from a depot as a regular delivery.

Although the invention's realizations are described and illustrated, it is obvious to someone skilled in the art to which the invention relates that modifications can be made to these realizations without altering the substance of the invention.

1. A system for optimizing the placement of at least one depot stop within a predetermined delivery route, said delivery route including deliveries, pick-ups or a combination thereof of at least two different services, for a multi-compartment vehicle, each compartment being associated with at least one service and being characterized by weight, volume and capacity and by incompatible services, said system comprising:
means for assigning starting quantities to each compartment;
means for evaluating said compartments in order to determine an optimal placement of said at least one depot stop, said means being adapted to:
create a transaction for each service at each stop;
scan each transaction to determine whether it is a delivery or a pick-up;
in the case of a delivery, for each compartment, determine if the service is incompatible, if there is underflow or overflow of the compartment and if the delivery can be split and reduce the quantity of the service in the respective compartment by using starting quantity if necessary;
in the case of a pick-up, for each compartment, determine if the service is incompatible, if there is overflow of the compartment and if the pick-up can be split, and updating the quantity of the compartment if the pick-up can be inserted into the compartment; and
repeating the steps until all services including previous stop services have been treated at said stop and moving to the next stop, where if said means determine an overflow condition, or an underflow condition, a depot stop is inserted into said route.

2. A computer implemented method for optimizing the placement of at least one depot stop within a predetermined delivery route, said delivery route including deliveries, pick-ups or a combination thereof of at least two different services, for a multi-compartment vehicle, each compartment being associated with at least one service and being characterized by weight, volume and capacity and by incompatible services, said method comprising the steps of:
assigning starting quantities to each compartment;
calculating an optimized placement for a depot virtual position for said vehicle based on services required by said customers and capacity of said compartments in order to avoid unnecessary stops at depots, said step of calculating including the sub-steps of:
creating a transaction for each service at each stop;
scanning each transaction to determine whether it is a delivery or a pick-up;
if it is a delivery, for each compartment, determining if the service is incompatible, if there is underflow or overflow of the compartment and if the delivery can be split, and then reducing the quantity of the service in the respective compartment by using starting quantity if necessary;
if it is a pick-up, for each compartment, determining if the service is incompatible, if there is overflow of the compartment and if the pick-up can be split, and updating the quantity of the compartment if the pick-up can be inserted into the compartment; and
repeating the above steps until all services including previous stop services have been treated at said stop and moving to the next stop;
inserting a depot stop in said route when an overflow condition or an underflow condition has been determined.
